(19) United States
(12) Patent Application Publication
(10) Pub. No.: US 2012/0072552 A1
(43) Pub. Date: Mar. 22, 2012

(54) Enabling Server Support of Client Specific Behavior

(76) Inventor: Eran Friedlander, Kfar Saba (IL)

(21) Appl. No.: 12/885,824

(22) Filed: Sep. 20, 2010

(51) Int. Cl. G06F 15/177

(52) U.S. Cl. 709/220

(57) ABSTRACT

A wireless device attempting to join a wireless network may provide its software version as part of the bootstrap process. A server may then check the software version to determine whether any workaround is needed and, if so, may provide the workaround in response to receiving the software version.

### BACKGROUND

This relates generally to wireless networks.

In wireless networks, new devices, called subscriber devices, may join the network in a procedure called bootstrapping. Bootstrap is a procedure to transfer information of a device management (DM) server, such as the address of the device management server, user name, and password to the subscriber device to enable the subscriber device to connect to the device management server and to establish a session with it.

Device management (DM) is a process of remotely managing device settings and applications. Device management provides a mechanism for users to easily subscribe to new services and make changes to their existing services. For operators, this enables a fast and easy way to introduce new services and to manage provision services, by dynamically adjusting the changes and assuring a certain level of quality of service.

A provisioning server is a management authority that has a right to perform a specific device management function on a device or to manipulate a given data element or parameter. A provisioning client is an agent in the device that is an extension of the provisioning protocol to support wireless requirements.

One wireless protocol, called WiMAX for Worldwide Interoperability for Microwave Access, provides fixed and fully mobile broadband Internet access. See WiMAX Forum Network Architecture, WMF-T33-103-RO15v02 (2009-Nov.-21), available from The WiMAX Forum® (hereinafter “WiMAX network architecture”) and the WiMAX standard IEEE 802.16-2009.

### BRIEF DESCRIPTION OF THE DRAWINGS

FIG. 1 is a system architecture depiction in accordance with one embodiment;

FIG. 2 is a flow chart for one embodiment of the present invention;

FIG. 3 is another flow chart for the embodiment shown in FIG. 2; and

FIG. 4 is still another flow chart for one embodiment of the present invention.

### DETAILED DESCRIPTION

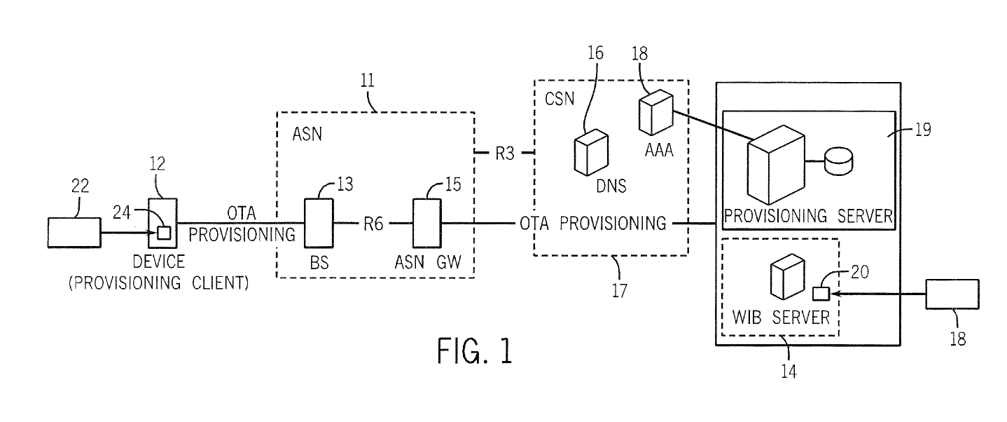

Referring to FIG. 1, a subscriber device, or provisioning client 12 may be coupled, for example, by over-the-air (OTA) provisioning to an access service network (ASN), in accordance with the WiMAX network architecture. The subscriber device may, for example, be a cellular telephone, personal digital assistant, or a laptop computer, as examples. The access service network 11 may include a base station (ES) 13 coupled by an RE connection to an access service network gateway (ASN GW) 15. The ASN 11 is coupled by an R3 connection to a connectivity service network or CSN 17, which includes a domain name system (DNS) 16 and an authentication, authorization, and accounting (AAA) server 18. The AAA server 18 may connect to a provisioning server 19. The provisioning server may be coupled by OTA provisioning to the ASN gateway 15. The provisioning server 19 may also be coupled to a WiMAX initial bootstrap (WIB) server 14.

The provisioning server 19 is a management authority that has the right to perform a specific device management function on a device or to manipulate a given data element or parameter. In accordance with the WiMAX standard for networks that support Open Mobile Alliance (OMA) DM based activation provisioning, the provisioning server supports the WiMAX OTA provisioning and activation based on OMA DM. See WiMAX Forum T33-104 R015v04, “Architecture, Detailed Protocols and Procedures, WiMAX Over-the-Air Provisioning & Activation Protocol based on OMA DM Specifications,” Release 1.5 (“OTAOMADM”). For networks that support DSL Forum TR-069 (CPE WAN Management Protocol, May 2004, and Amendment I, November 2006, available from DSL Forum (DSLTR-069)) based activation and provisioning, the provisioning server supports the WiMAX OTA provisioning and activation based on the TR-069 protocol, as specified in WiMAX Forum 133-105 RO15v01, “Architecture, Detailed Protocols and Procedures, Over-the-Air Provisioning & Activation Protocol based on TR-069 Specification,” Release 1.5, (“OTATR-069”).

The provisioning client is an agent in the device 12 that is an extension of the provisioning protocol to support the WiMAX requirements. For devices that support OMA DM based activation and provisioning, the provisioning client supports WiMAX OTA provisioning and activation based on OMA DM, as specified in OTAOMADM. For devices that support DSLTR-069 based activation and provisioning, the provisioning client supports WiMAX OTA provisioning and activation based on TR-069, specified in OTATR-069.

The WiMAX initial bootstrap (WIB) procedure enables the discovery and negotiation of the device management OTA protocol to be used between the device and the network. The procedure includes a WIB server discovery using DNS SRV records [RSC2782 “A DNS RR for specifying the location of services (DNS SRV)”, A. Gulbrandsen, P. Vixie, L. Esibov, February 2000, available from the Internet Engineering Task Force (IETF)] and WIB OTA protocol negotiation using simple hypertext transfer protocol (HTTP) between the device and the WIB server.

The device 12 initiates the WIB server discovery and protocol negotiation upon obtaining a point of attachment Internet Protocol address using Dynamic Host Configuration Protocol (DHCP) and provides information about the OTA protocol it supports to the WIB server using the HTTP GET method. The WIB server uses the information provided by the provisioning client, selects an appropriate OTA protocol, and provides OTA protocol specific bootstrap information about the selected protocol in the HTTP response. For example, the provisioning client may include a WIB client. If a mutually supported OTA protocol cannot be selected, the WIB server responds with an HTTP error, and the OTA provisioning cannot proceed. With the successful execution of the bootstrapping process, a secure path between the device's provisioning client and the DM provisioning server can be established and the protocol specific provisioning process for the device can begin.

The WIB server is a functional entity that enforces OTA DM protocol for a particular domain and may store the configuration bootstrap, may act as a proxy to deliver the bootstrap information, or may redirect the device to another server that can deliver the bootstrap information.

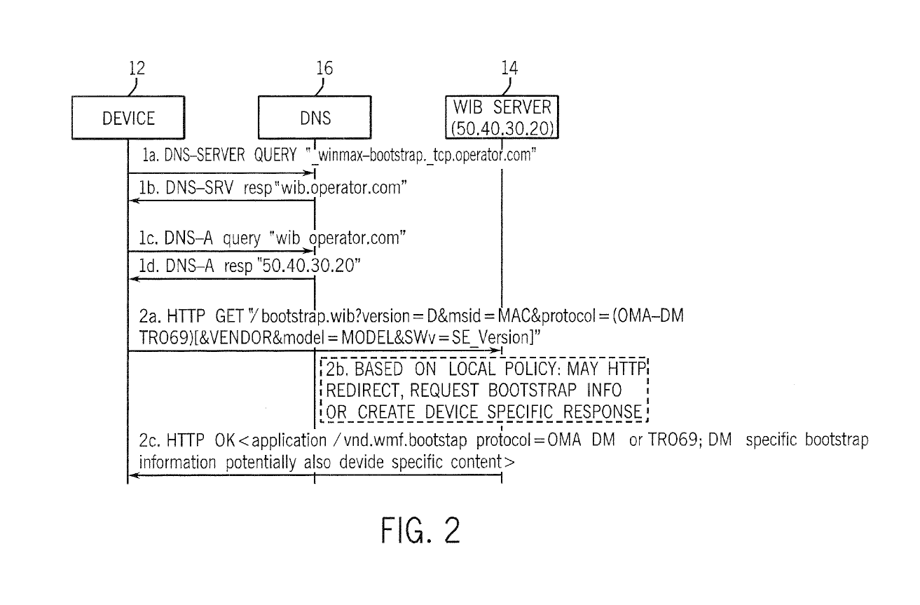

Thus, in one embodiment, shown in FIG. 2, the device 12 forwards a DNS-SRV query 1a (wimax-bootstrap._tcp.operator.com) to the DNS server 16. The DNS server 16 responds with a DNS-SRV response 1b (wib.operator.com). Then the device 12 provides a DNS-A or address query 1c (wib.operator.com) to the DNS server 16, which responds with a response 1d of 50.40.0.20, which is the WIB server's Internet Protocol address. Finally, the device 12 provides an HTTP GET service request 2a to the WIB server 14 using that address. The WIB server responds with response 2c, which may, in some cases, be device specific based on the software version member indicated in the request. As indicated at 2b, based on local policy, the WIB server may redirect, request bootstrap information, or create a device specific response.

In one embodiment, the device sends the following request: HTTP GET “/bootstrap.wib?version=0&msid=MAC&protocol={OMA-DM,TR069}[&vendor=VENDOR&model=MODEL&SWv=SW_Version]”. Thus, the device adds an optional parameter that identifies the software version. With this software version information, the server may provide a device specific response. For example, in case the device is faulty, workarounds can be employed. In other cases, new services or updates may be provided for devices that are not faulty. For example, the device software may have been released theoretically without any problems. The server receives the device request and then ignores the optional software version parameter because there is no use for it. The server just sends back the same standard response to all devices. If, at some later point in time, there is a problem revealed in the device implementation, the server can implement device specific logic that filters a request according to a device's type and software version and can provide faulty devices with responses that work around the device implementation problem.

Sending the software version parameter allows the server to overcome problems with the device that are currently known or become known in the future. Devices that send this parameter can benefit from the mechanism server originated workarounds without the need to update the device software.

Thus, in some embodiments, the device sends enough information to allow the identification of the device in a way that permits providing specific responses when a need arises. Of course, it is possible to provide device specific information equivalent to the software version or to add the software version (SWv) in any other parameter of the protocol.

Using the SWv parameter enhances the operation of the protocol because other parameters that are currently defined in the WIB protocol are not sufficient to send the software version. With the SWv parameter, it is possible to embed the software version without abusing the original intention, in some embodiments, in that there is no substantial impact on other mechanisms.

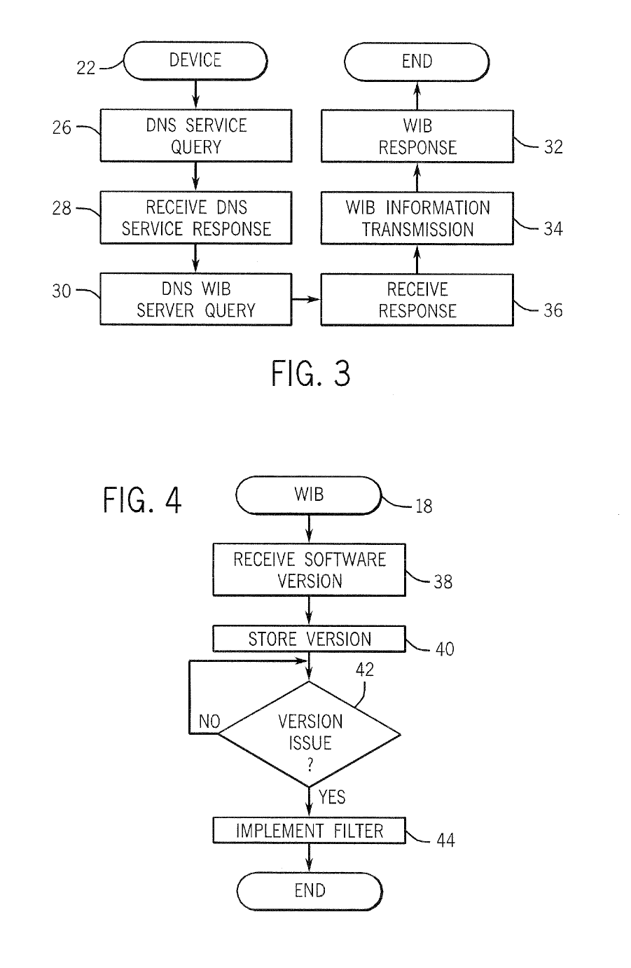

Thus, referring to FIG. 3, in one embodiment, a device side sequence 22 may be implemented in hardware, software, or firmware. In a software embodiment, the software may be implemented by a series of processor executable instructions stored in a non-transitory computer readable medium, for example, as indicated as a storage 24 in the device 12, shown in FIG. 1. The device 12 may include or be a processor. The medium may be a semiconductor or optical or magnetic storage. The sequence may begin by doing a DNS service query, as indicated at block 26. This may be followed by receiving a DNS service response, as indicated in block 28. A DNS WIB server query is provided at 30, followed by receipt of a response at 36. The WIB information transmission occurs at 34 with an ensuing response being received at 32. In some cases, the response may be device specific, including workarounds, if needed.

From the server side, a sequence 18 may also be implemented in software, hardware, or firmware. In a software based embodiment, it may be implemented by a sequence of processor executable instructions stored in a non-transitory computer readable medium, such as a semiconductor memory. Thus, as indicated in FIG. 1, in one embodiment, the sequence 18 may be stored in storage 20 within the WIB server 14, which may be or include a processor.

The server 14 receives the software version 38, as indicated at 38, and stores that version, as indicated at 44. A check at 42 determines whether there is any issue with any particular version that would require a workaround or filter. For example, the check may compare the received software version to a table of software versions that require a workaround. If so, the filter is applied, as indicated at 48, from the server end.

A device that does not support OMA DM or TR-069 server initiated bootstrap may use the WIB procedure based on DNS and HTTP. The device may perform a DNS SRV query [RFC2782] to resolve the location of the WIB server upon Internet Protocol session establishment. The service and the SRV query may be “wimax-bootstrap.” The protocol and the SRV query may be “tcp.” If the target Network Service Provider (NSP) realm is available, the Name in the SRV query may be the domain of the target NSP realm. If the target NSP realm is not available from the IEEE 802.16 Session Border Controller Response (SBC-RSP), the name in the SRV query may be the domain name obtained from the DHC procedure (DHCP option 15 [RFC2132]). The DNS server may resolve this domain name issue to the Fully Qualified Domain Name (FQDN) of the WIB server of the NSP. In some embodiments, the bootstrap information may be provided to advise using the format defined for the bootstrap, such as application/vnd.wmf.bootstrap. The bootstrap information may include a fixed sized header, followed by variably sized data. The header may include a field for version with two octets, protocol with two octets and length with four octets. The data may be any variable from zero to 2¹⁶-9. The octet's significance may be most significant bit and least significant bit for the headers and may be DM protocol specific for the data. The values for the version may be zero or one to 65535=reserved. The values for the protocol may be a value defined as the type of device, such as WiMAX CPE gateway, OMA DM-mandatory, TR-069 mandatory, or other WiMAX devices. The value for length may be data length as the number of octets. The version field may contain the value zero for the initial version of the protocol.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a software version of a wireless device attempting to join a network to be identified.

2. The method of claim 1 including enabling the wireless device to provide a software version during bootstrapping.

3. The method of claim 2 including, in response to a wireless device providing a domain name service query, providing an address for an initial bootstrap server.

4. The method of claim 4 including enabling the wireless device to contact the initial bootstrap server and including with that contact, information about the software version used by the device.

5. The method of claim 4 including enabling the bootstrap server to determine whether the particular software version needs workaround and, if so, providing a device specific response including that workaround.

6. The method of claim 1 including using a WiMAX initial bootstrap over the air protocol to negotiate an initial bootstrap.

7. The method of claim 6 including using hypertext transfer protocol messages to institute the initial bootstrap.

8. A non-transitory computer readable medium storing instructions that enable a processor to:
identify a software version of a wireless device attempting to join a wireless network.

9. The medium of claim 8 further storing instructions to receive information about the software version during initial bootstrap.

10. The medium of claim 9 further storing instructions to compare the software version to a table of software versions that need a workaround.

11. The medium of claim 10 further storing instructions to provide a workaround in response to the provision of said software version.

12. The medium of claim 8 further storing instructions to use a WiMAX initial bootstrap over the air protocol to negotiate an initial bootstrap.

13. The medium of claim 12 further storing instructions to use hypertext transfer protocol messages initiate the initial bootstrap.

14. An apparatus comprising:
an initial bootstrap server to identify a software version of a wireless device attempting to join a wireless network based on model number and software version information received from said device; and
a storage storing instructions for execution by said server.

15. The apparatus of claim 14 wherein said apparatus is WiMAX initial bootstrap server.

16. The apparatus of claim 14, said server to receive information about the software version of a wireless device attempting to join a wireless network during initial bootstrap.

17. The apparatus of claim 16, said server to compare the software version to a table of software versions that need a workaround.

18. The apparatus of claim 17, said server to provide a workaround in response to a provision of said software version.

19. The apparatus of claim 14, said server to use a WiMAX initial bootstrap over the protocol to negotiate initial bootstrap.

20. The apparatus of claim 19, said server to use hypertext transfer protocol messages to initiate the initial bootstrap.
